(19) United States
(12) Patent Application Publication
(10) Pub. No.: US 2016/0063627 A1
(43) Pub. Date: Mar. 3, 2016

(54) TREND TRACKING METHOD

(71) Applicant: Research Foundation of the City University of New York, New York, NY (US)

(72) Inventors: Michael Carlisle, New York, NY (US); Olympia Hadjiliadis, New York, NY (US); Ioannis Stamos, New York, NY (US)

(21) Appl. No.: 14/840,477

(22) Filed: Aug. 31, 2015

Related U.S. Application Data
(60) Provisional application No. 62/043,886, filed on Aug. 29, 2014.

(51) Int. Cl. G06Q 40/04

(52) U.S. Cl. CPC G06Q 40/04

(57) ABSTRACT

A method of establishing a cumulative sum (CUSUM) tracking strategy that limits large positions is disclosed. The method monitors the price of an asset over time and classifies changes as an upward or downward trend. An upward cumulative and downward cumulative sum are compared to thresholds. An alarm is fired when a threshold is exceeded. A buy action is performed during the upward trend or a sell action is performed during the downward trend. The method is restarted with newly-initialized upward cumulative sum and downward cumulative sum when the alarm is triggered.

### CROSS-REFERENCE TO RELATED APPLICATIONS

This application claims priority to and is a non-provisional of U.S. Patent Application Ser. No. 62/043,886 (filed Aug. 29, 2014) the entirety of which is incorporated by reference.

### STATEMENT OF FEDERALLY SPONSORED RESEARCH OR DEVELOPMENT

This invention was made with Government support under Contract number 0916452 awarded by the NSF-CCF-MSC and Contract number 1222526 awarded by the NSF-DMS. The government has certain rights in the invention.

### BACKGROUND OF THE INVENTION

The subject matter disclosed herein relates to trend tracking in various fields including, for example, financial markets.

High-frequency data in finance is often characterized by fast fluctuations and noise, a trait that is known to make the volatility of the data very difficult to estimate. Although this characteristic creates many challenges in modeling, it offers itself to the study of distinguishing “signal” from “noise”—a topic of interest in the area of quickest detection. A popular algorithm used in quickest detection is known as the cumulative sum (CUSUM) stopping rule. Stopping rules provide a way to develop a strategy that offers the detection of directional trends. This, for example, eliminates the risk of large positions in volatile financial markets.

The discussion above is merely provided for general background information and is not intended to be used as an aid in determining the scope of the claimed subject matter.

### BRIEF DESCRIPTION OF THE INVENTION

A method of establishing a cumulative sum (CUSUM) tracking strategy that limits large positions is disclosed. The method monitors the price of an asset over time and classifies changes as an upward or downward trend. An upward cumulative and downward cumulative sum are compared to thresholds. An alarm is fired when a threshold is exceeded. A buy action is performed during the upward trend or a sell action is performed during the downward trend. The method is restarted with newly-initialized upward cumulative sum and downward cumulative sum when the alarm is triggered.

In one embodiment, a method of establishing a cumulative sum (CUSUM) tracking strategy that limits large positions and identifies real trading trends is provided. The method comprising steps of a) monitoring a sequence (Yₙ) of data points over time, the sequence of data points corresponding to a price of an asset; b) classifying a change in price at time (n) relative to time (n 1) by a sequence trend, the sequence trend selected from an upward trend (u) in the price or a downward trend (d) in the price; c) calculating an upward cumulative sum (uₙ) of a possible upward trend (u) and a downward cumulative sum (dₙ) of a possible downward trend (d); d) comparing the upward cumulative sum (uₙ) to an upward threshold (h⁺) and the downward cumulative sum (dₙ) to a downward threshold (h⁻) to determine deviation from a mean by an amount greater than the respective threshold, wherein an alarm is fired when the respective threshold is exceeded, the alarm having an alarm type selected from an upward alarm type and a downward alarm type corresponding to the upward trend (u) and the downward trend (d), respectively, wherein only one alarm type may fire at a time; e) performing a buy action that buys at least one share of the asset during the upward trend or performing a sell action that sells at least one share of the asset during the downward trend; f) repeating steps a) to e) for successive changes in price until the alarm is fired denoting an end of the sequence trend and thereafter: initiating a sell action at an end of the upward trend or initiating a buy action at an end of the downward trend; and restarting the method with newly-initialized upward cumulative sum (uₙ) and downward cumulative sum (dₙ).

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a graph depicting asset price along with number of shares held, per-subperiod gain, and running total gain;

FIG. 2 is a graph depicting individual subperiod gains, plotted by number of signals during for Aug. 2, 2011 for 5-year notes;

FIG. 3 is a graph depicting individual subperiod gains, plotted by number of signals during for Jul. 29, 2011 for 30-year notes;

FIG. 4 is a graph depicting individual subperiod gains, plotted by number of signals during for Aug. 1, 2011 for 30-year notes;

FIG. 5 is a graph depicting individual subperiod gains, plotted by number of signals during for Aug. 2, 2011 for 30-year notes;

FIG. 6 is a graph depicting individual subperiod gains, plotted by number of signals during for Aug. 3, 2011 for 30-year notes;

FIG. 7 is a graph that aggregates data from FIGS. 3-6 for 30-year notes;

FIG. 8A graphs small variations in thresholds;

FIG. 8B graphs large variations in thresholds;

FIG. 9A graphs the number of signals per trading day decreases at the rate of the square root of a small threshold;

FIG. 9B graphs the number of signals per trading day decreases at the rate of the square root of a large threshold; and

FIG. 10 is a schematic depiction of a processor system for use with the disclosed method.

### DETAILED DESCRIPTION OF THE INVENTION

Disclosed in this specification is a trend tracking method. Various embodiments described herein are more efficient than current trading methods due to a reduction in large positions vulnerable to being set by noise rather than signal. By providing a method where once an upward/downward CUSUM alarm (called a “signal”) goes off, there is a buy/short sale of a variable number of units of the underlying asset. Thereafter a CUSUM based stopping rule is repeated and for every alarm of the same sign as the initial signal, a buy/short sale is repeated until a CUSUM sign of the opposite sign is set off, at which time all that was bought is sold, or all that was short sold is bought. Instability in price is enough to lead to profit regardless of the nature or sign of the direction of the movement.

In one embodiment, CUSUM stopping rules are provided in order to construct an online trading strategy. This strategy takes advantage of the relatively frequent number of alarms CUSUM stopping times may provide when applied to high-frequency data as a result of the fast fluctuations present therein. The trading strategy implemented settles frequently and thus eliminates the risk of large positions. This makes the strategy implementable in practice. Prior techniques run high risks of great losses mainly due to the randomness associated with settling. The well-known trailing stops strategy is also related to the filter strategy and thus suffers similar risks.

In one embodiment, a method of establishing a general tracking strategy that limits, in the example of a trading strategy, large positions and identifies real trading trends, comprising the following steps: a) providing a first CUSUM based stopping rule for detecting upward change in the observed (financial) data; b) providing a second CUSUM based stopping rule for detecting downward change in the observed (financial) data; c) running the first CUSUM based stopping rule and the second CUSUM based stopping rule in parallel; d) initiating an action, whose type is dependent on which CUSUM based stopping rule alarm is set off first (a “buy” or “sell”); e) repeating the action type for successive alarms of the same kind as the one that initiated the action in d), until the other alarm type is set off; f) initiating a different action (a “sell-off”′ or “buy-up”) to signal an end of the trend; g) restarting the process with newly-initialized CUSUM stopping rules; h) repeating the steps a)-g) until an external application orders a termination of the process. The high frequency of CUSUM alarms in high-frequency tick data permits the implementation of this rule in practice since large exposures on one side, whether on the buy or on the sell side, are settled relatively quickly.

The method is applied on real tick data of a 30-year asset and a 5-year note sold at auction on various individual days. It is seen that the algorithm is most profitable in the presence of upward or downward trends (referred to as “subperiods”), even in the presence of noise, and is less profitable on periods of price stability.

In order to quantify the performance of the disclosed method, its expected reward was calculated in a simple random walk model. Diagnostic plots indicate that the more biased the random walk is, the more profitable the proposed strategy becomes, which is consistent with the actual findings when the strategy is applied to real data. This is because in the presence of a bias, trends are more likely to form than in the absence of a bias.

The method uses an analytical approach of discrete data and a linear random walk model, rather than taking the continuous approach via, for example, the geometric Brownian motion model, because the movement of individual ticks of a price is being analyzed, quantized in a linear fashion (for example, at the level of 1 cent, 1/32 cent, or 1/64 cent). The disclosed models focus on tracking the motion of an asset price via these ticks, and so a linear approach would be a more realistic setting when short interest rate effects would be minimal.

General Trading Strategy

Let {Sₙ}_{n=0,1,2} . . . be a sequence of data points. For the present example, the data points will be samples of the price of an asset. S₀ is a constant and Sₖ=0 for some k implies that Sₙ=0 for all n>k. Let T₀=0 and define Tₖ, k=1,2, . . . as an increasing sequence of (stopping) times, called signals, noting some trend in the sequence. Tₖ is called the kth signal.

A trading strategy is constructed in the case that there are two types of signals: “+signals” (declaring the detection of an upward trend in the data) and “−signals” (declaring the detection of a downward trend in the data). Let “Property+(k)” be the property that causes a +signal to occur as the kth signal, and denote this event by {Tₖ=Tₖ⁺}. Likewise, let “Property−(k)” be the property that causes a − signal to occur as the kth signal, and denote this by {Tₖ=Tₖ⁻}. Only one type of trend can be detected at a time, so define Tₖ⁻ and Tₖ⁻ by:

$$\begin{matrix}{T}_{k}^{+} = \{ \begin{matrix}{T}_{k} & if Property + ( k ) occurs \\ ∞ & if Property - ( k ) occurs\end{matrix} & ( 1 ) \\ {T}_{k}^{-} = \{ \begin{matrix}{T}_{k} & if Property - ( k ) occurs \\ ∞ & if Property + ( k ) occurs\end{matrix} & ( 2 )\end{matrix}$$

Thus, Tₖ=Tₖ⁺ [symbol] Tₖ⁻ for every k=1,2, . . .

The data is then defined to be within a trend by setting a sequence of signal indices α(1) as follows: let α(0)=0 so T_{α(0)}=0, and for l≧1 with k≧2 define the properties.

“Property+(l,k)”: Tⱼ=Tⱼ⁻ for every α(l−1)<j<k and Tₖ=Tₖ⁺

“Property−(l,k)”: Tⱼ=Tⱼ⁺ for every α(l−1)<j<k and Tₖ=Tₖ⁻

The lth shift point is defined, for l=1,2, . . . , given

α(l):=inf{k≧α(l−1)+2: Property+(l,k) or Property−(l,k)holds}. (3)

Note that T_{α(l)} is at least two signals after T_{α(l-1)}. The definition of α(l) is equivalent to

α(l):=inf{k≧α(l−1)+2: Tₖ has different sign than Tⱼ,α(l−1)<j<k}. (4)

A sequence of the same type of signal is called a subperiod of the sample points. A shift point denotes the end of a subperiod of the same type of signal.

Let Δₙ be the number of shares of the asset S held at time n. Set Δ₀=0. For every n ε(T_{α(l)}, T_{α(l+1)}) the sign of Δₙ is invariant, i.e. either Δₙ>0 holds for every n ε(T₍ₗ₎, T_{α(l+1)}) or Δₙ<0 holds for every n ε(T_{α(l)}, T_{α(l+1)}).

The trading strategy is as follows: for f(n) and g(n) positive functions of n,

$${Δ}_{n + 1} = \{ \begin{matrix}{Δ}_{n} & if no signal at time n , i . e . n \neq {T}_{j} ∀ j ( no charge ) \\ {Δ}_{n} + f ( n ) & if n = {T}_{j} = {T}_{j}^{+} for some j , α ( l ) < j < α ( l + 1 ) for some l \\ & ( buy f ( n ) during a + subperiod ) \\ {Δ}_{n} - g ( n ) & if n = {T}_{j} = {T}_{j}^{-} for some j , α ( l ) < j < α ( l + 1 ) for some l \\ & ( sell g ( n ) during a - subperiod ) \\ 0 & if n = {T}_{α ( l )} for some l \geq 1 \\ & ( buy - up if {T}_{α ( l )}^{+ 1} ; sell - off if {T}_{α ( l )}^{-} )\end{matrix} \qquad ( 5 )$$

A market in which all market orders are instantly fulfilled was assumed for testing purposes.

Gain Over a Subperiod

The gain Gₗ, l=1,2, . . . , is analyzed over the time period T_{α(l-1)}, T_{α(l)}, called subperiod l. This is the amount of cash earned or lost by liquidating the transactions made from signals T_{α(l-1)+1}, . . . T_{α(l)-1} at T_{α(l).}

A subperiod is determined by the first signal on a given run: if T₁=T₁⁺ then the run from the first signal to signal α(1)−1 is a “bull run” subperiod of individual buy orders followed by a sell-off at time T_{α(1)}=T_{α(1)}⁻. If T₁⁻ then this run is a “bear run” subperiod of individual short sales followed by a buy-up at T_{α(1)}=T_{α(1)}⁺. G₁ is defined to be the gain on subperiod l, thus G₁ is the gain on the first subperiod, starting at signal T_{α(0)+1}=T₁ and ending at a signal T_{α(1)}. The sign of the first signal of the subperiod is given as a starting condition. Let c≧0 be the percentage cost per transaction and define:

$${A}_{l} := {1}_{\{ {T}_{α ( l - 1 ) + 1 = {T}_{α ( l - 1 ) + 1}^{-}} \}} , \\ {Y}_{l} := α ( l ) - α ( l - 1 ) - 1 \qquad ( 6 )$$

The gain over subperiod l is, for the embodiment f(n)=1, g(n)=1,

$${G}_{l} = ( c + {( - 1 )}^{A 1} ) {\sum }_{j = 1}^{{Y}_{l}} {jZ}_{j + α ( l - 1 )} - 2 {cY}_{l} {S}_{α ( {T}_{l} )} \qquad ( 7 )$$

In the absence of transaction costs (e.g. c=0) the expected gain G₁ is entirely determined by price increments and the sign of the first signal of the subperiod.

CUSUM Timing

A version of a CUSUM statistic process and its associated CUSUM stopping rule will now be described. This will be used to devise a timing scheme based on the quickest detection of trends and incorporate this scheme to a trading strategy.

CUSUM Process and Stopping Time

A measurable space (Ω= [symbol] ∞, F=∪ₙFₙ), where Fₙ=σ{Yᵢ, i ε{0,1, . . . , n}}. The law of the sequence Yᵢ, i=1, . . . is described by the family of probability measures Pₖ, k ε [symbol] *. In other words, the probability measure Pᵥ for a given k>0, playing the role of the change point, is the measure generated on Ω by the sequence Yᵢ, i=1, . . . when the distribution of the Yᵢ's changes at time k. The probability measures P₀ and P_{∞} are the measures generated on Q by the random variables Yᵢ when they have an identical distribution. In other words, the system defined by the sequence Yᵢ undergoes a “regime change” from the distribution P₀ to the distribution P_{∞} at the change point time k.

The CUSUM statistic is defined as the maximum of the log-likelihood ratio of the measure Pₖ to measure P_{∞} on the σ-algebra Fₙ. That is,

$${C}_{n} := {max}_{0 \leq k \leq n} log \frac{d {P}_{k}}{d {P}_{∞}} {\vert}_{{F}_{n}} \qquad ( 8 )$$

is the CUSUM statistic on the σ-algebra Fₙ. The CUSUM statistic process is then the collection of the CUSUM statistics {Cₙ} of (8) for n=1, . . . . The CUSUM stopping rule is then

$$T ( h ) := inf \{ n \geq 0 \text{:} {max}_{0 \leq k \leq n} log \frac{d {P}_{k}}{d {P}_{∞}} {\vert}_{{F}_{n}} \geq h \} , \qquad ( 9 )$$

for some threshold h>0. In the CUSUM stopping rule (9), the CUSUM statistic process of (8) is initialized at C₀=0.

As a specific example, a form of the original CUSUM is now stated, in two cases. To this effect let Yᵢ˜N(μ₀,σ²). These random variables Yᵢ change to Yᵢ˜N(μ₁,σ²) at the change point time k. Case 1: μᵢ>μ₀: the CUSUM stopping rule T⁺ has the form

$${T}^{+} ( {h}^{+} ) = inf \{ n \geq 0 \text{:} {max}_{0 \leq k \leq n} {\sum }_{i = k}^{n} [ {Y}_{i} - \frac{{μ}_{1} + {μ}_{0}}{2} ] \geq {h}^{+} \} \qquad ( 10 )$$

for an appropriately scaled threshold h⁺>0.

Case 2: μ₁<μ₀: the CUSUM stopping rule T⁻ has the form

$${T}^{-} ( {h}^{-} ) = inf \{ n \geq 0 \text{:} {max}_{0 \leq k \leq n} {\sum }_{i = k}^{n} [ \frac{{μ}_{1} + {μ}_{0}}{2} - {Y}_{i} ] \geq {h}^{-} \} \qquad ( 11 )$$

for an appropriately scaled threshold h⁻>0.

The stopping times may be re-expressed in terms of the recurrence relations

$$\begin{matrix}{u}_{0} = 0 ; \\ {u}_{n} := max \{ 0 , {u}_{n - 1} + ( {Y}_{n} - \frac{{μ}_{1} + {μ}_{0}}{2} ) \} & ( 12 ) \\ {d}_{0} = 0 ; \\ {d}_{n} := max \{ 0 , {d}_{n - 1} + ( {Y}_{n} - \frac{{μ}_{1} + {μ}_{0}}{2} ) \} & ( 13 )\end{matrix}$$

which lead to

T⁺(h⁺)=inf{n>0:uₙ≧h⁺} (14)

T⁻(h⁻)=inf{n>0: dₙ≧h⁻} (15)

The sequences uₙ and dₙ form a cumulative sum according to the deviation of the monitored sequential observations Yₙ from the average of their pre- and post-change means. The first time that one of these sequences reaches its threshold, the respective alarm T⁺ or T⁻ fires.

Although the stopping times T⁺ and T⁻ can be derived by formal CUSUM regime change considerations using the example set forth in this section, they may also be used as general non-parametric stopping rules directly applied to sequential observations. The former can be used as a general stopping rule to detect an upward change in the mean while the latter a downward one. In many applications it is of interest to monitor an upward or a downward change in the mean of sequential observations simultaneously. This gives rise to the two-sided CUSUM (2-CUSUM) in the mean of sequential observations simultaneously. This gives rise to the 2-CUSUM whose optimality properties have been established. In the context of the current specification, the 2-CUSUM takes the form

T⁺(h⁺) [symbol] T⁻(h⁻) (16)

The aforementioned CUSUM stopping rule T+(h⁺) [symbol] T⁻(h⁻) is now applied to a stream of data representing the value of the underlying asset without any model assumptions. In other words, the underlying asset is not necessarily assumed to be independent or normally distributed. That is, the forms T⁺ and T⁻ are applied in a non-parametric fashion. Let M>0 denote the “tick size” of the asset being monitored (presuming that S changes in increments of M; the probability distribution of these changes is not known), and h⁺, h⁻>0 be given thresholds. Given that S₀=s, recall that T₀=0. The progress of upward or downward adjustments in the price Sₙ of the underlying is monitored by individual ticks.

In view of the previous subsection at time Tₖ, μ₀ is set to the value of the underlying at time Tₖ, namely μ₀=S_{T}_{ₖ}+M, and μ₁^{u}=S_{T}_{ₖ}+M and μ₁^{d}=S_{T}_{ₖ}−M are the two “new” mean levels to be monitored against. Thus, the deviations of the underlying sequence Sₙ, n=1, 2 . . . are now monitored from the quantities

$${m}_{k}^{u} := \frac{( {S}_{{T}_{k}} + M ) + {S}_{{T}_{k}}}{2} = {S}_{{T}_{k}} + \frac{M}{2} \\ {m}_{k}^{d} := \frac{( {S}_{{T}_{k}} - M ) + {S}_{{T}_{k}}}{2} = {S}_{{T}_{k}} - \frac{M}{2} \qquad ( 17 )$$

where k≧0. To this effect, set uₙ^{k}=d₀^{k}=0, and for n≧1, define the CUSUM statistics

uₙ^{k}:=max{0,uₙ₋₁^{k}+(S_{n+T}_{ₖ}−mₖ^{u})}

dₙ^{k}:=max{0,dₙ₋₁^{k}+S_{n+T}_{ₖ}−mₖ^{d})} (18)

Thus, for k≧0, the CUSUM timing scheme for our trend-following trading strategy is defined by

Property+(k+1): uₙ^{k}≧h⁺;Property−(k+1):dₙ^{k}≧h⁻

jₖ*:=min{n>0:Property+(k+1) or −(k+1)occurs}

Tₖ₊₁:=Tₖ+jₖ* (19)

CUSUM Timing

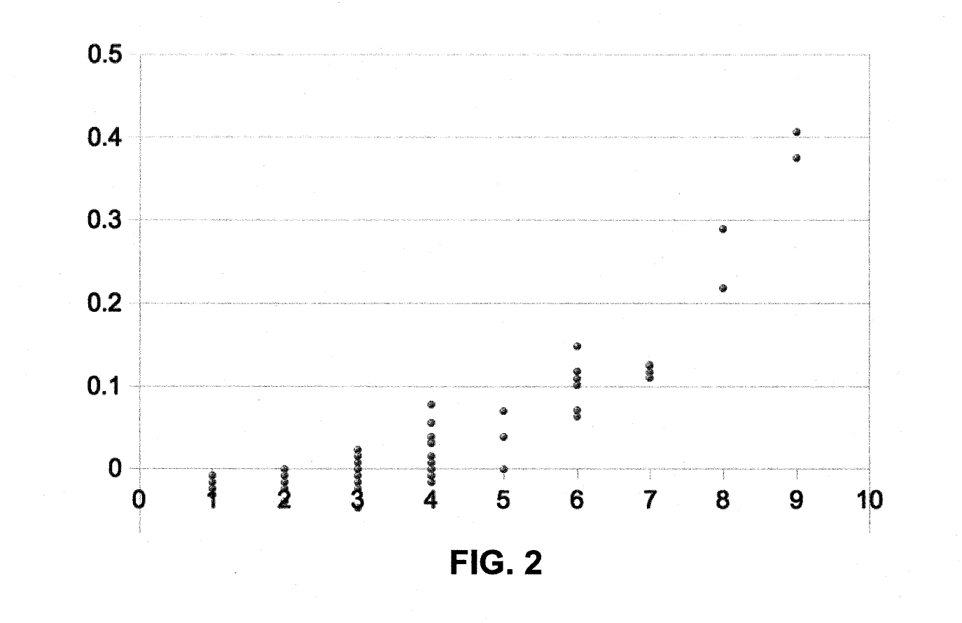

FIGS. 2 to 7 apply the disclosed method to the trading of U.S. Treasury notes sold at auction in 2011. Gains quoted are in increments of $1000.

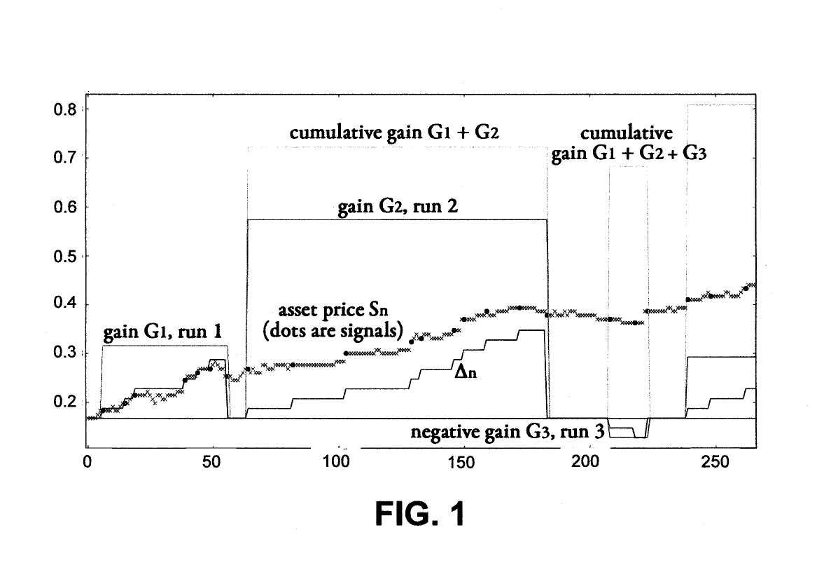

FIG. 1 shows the asset price along with the number of shares held, per-subperiod gain, and running total gain.

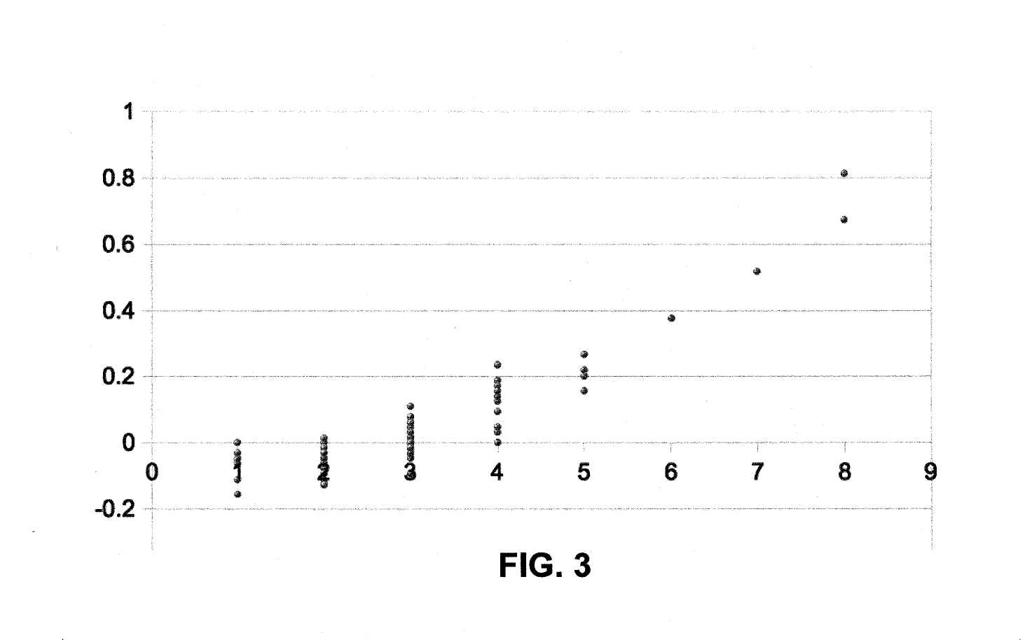

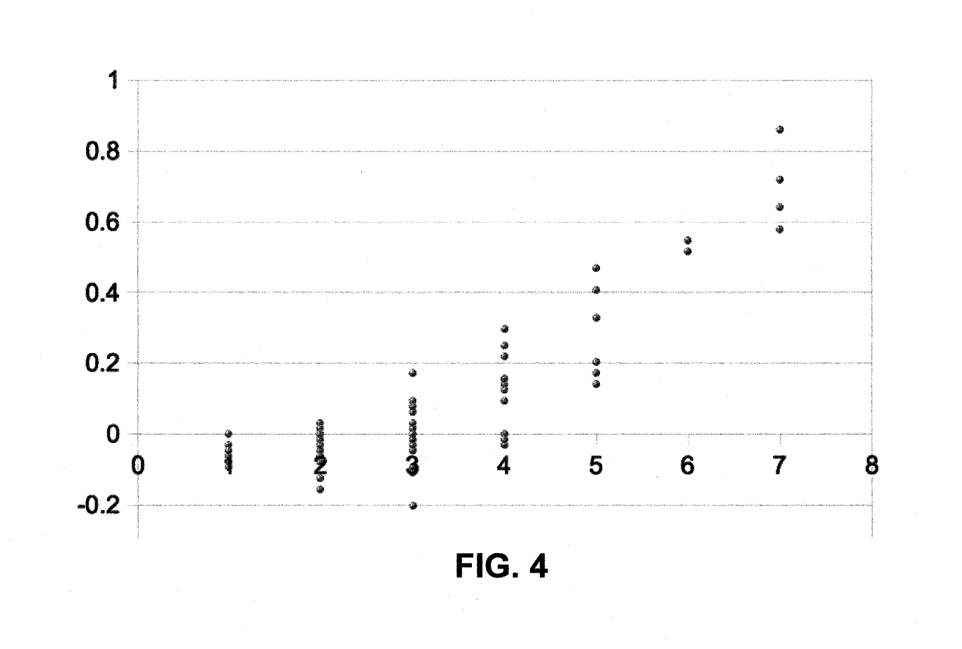

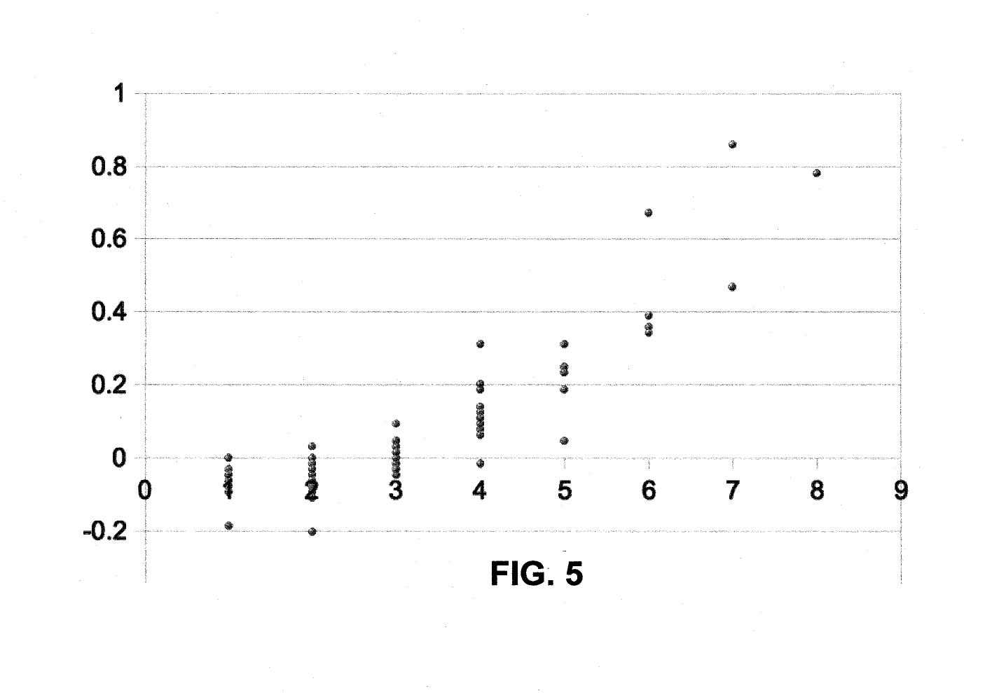

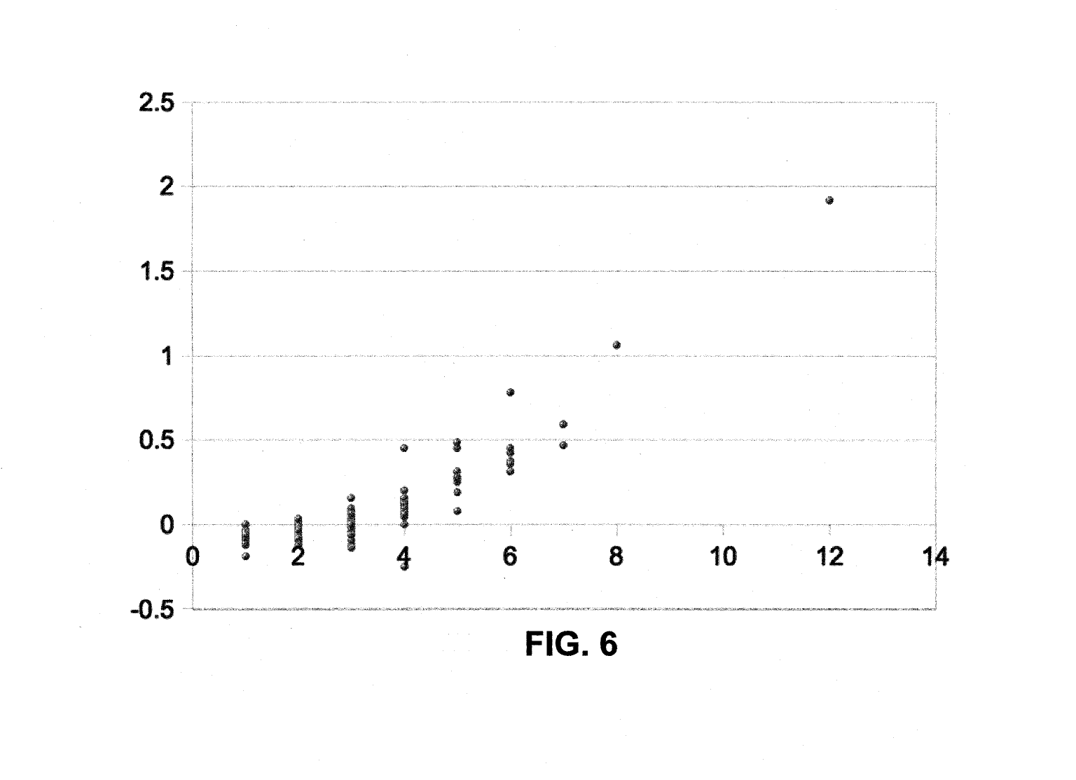

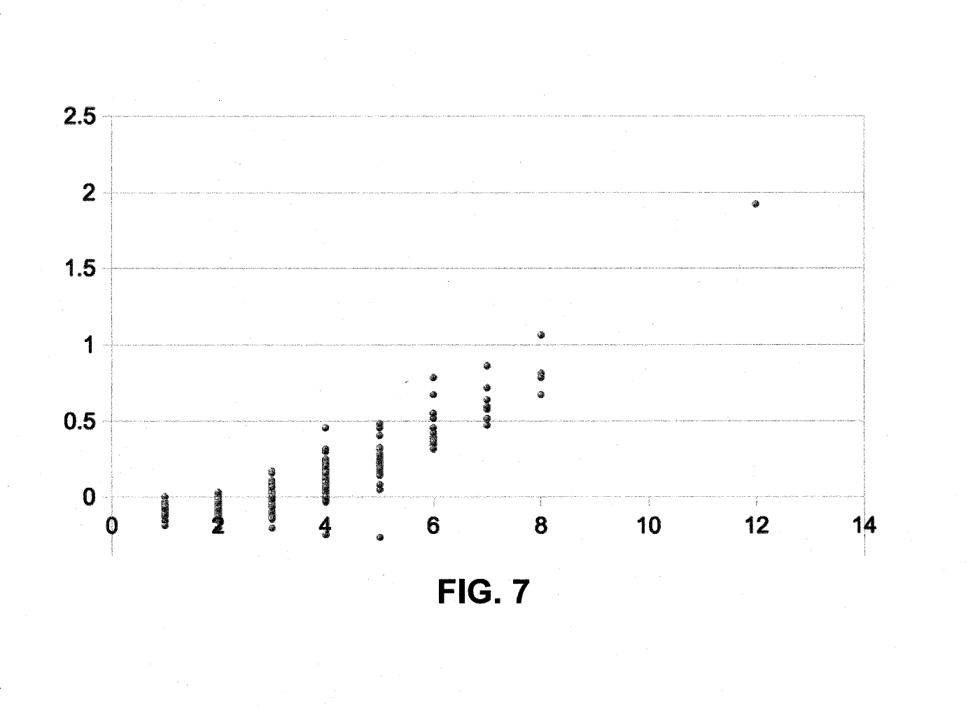

FIGS. 2-6 show individual subperiod gains, plotted by number of signals during a subperiod, of the gain for 5-year and 30-year treasury notes. Specifically, FIG. 2 is for Aug. 2, 2011 for 5-year notes. FIG. 3 is for Jul. 29, 2011 for 30-year notes. FIG. 4 is for Aug. 1, 2011 for 30-year notes. FIG. 5 is for Aug. 2, 2011 for 30-year notes. FIG. 6 for Aug. 3, 2011 for 30-year notes. FIG. 7 aggregates the data from FIGS. 3-6 for 30-year notes.

CUSUM Strategy Monte Carlo

Monte Carlo simulations of a collection of random walks on ticks will now be provided to numerically analyze the behavior of the disclosed method against such walks as asset prices.

The two classes of random walks for our simulations are the lazy symmetric simple random walk

$${X}_{j} = \{ \begin{matrix}+ 1 & + 1 with probability {p}_{1} = \frac{1 - {p}_{0}}{2} \\ 0 & with probability {p}_{0} ∈ \{ 0 , 0.05 , 0.1 , … , 0.35 \} \\ - 1 & with probability {p}_{- 1} = \frac{1 - {p}_{0}}{2}\end{matrix} \qquad ( 20 )$$

and the lazy asymmetric simple random walk with upward drift

$${X}_{j} = \{ \begin{matrix}+ 1 & with probability {p}_{1} = 0.5 - \frac{{p}_{0}}{2} + 0.05 j , j ∈ \{ 0 , 1 , … , 6 \} \\ 0 & with probability {p}_{0} ∈ \{ 0 , 0.1 , 0.2 , 0.3 , 0.4 \} \\ - 1 & with probability {p}_{- 1} = 1 - {p}_{1} - {p}_{0}\end{matrix} \qquad ( 21 )$$

where Xⱼ model incremental changes in the asset price S, and j allows p₋₁>0.

Define the idle time of a trading strategy during a day as the (random) set of tick times between subperiods, i.e. when our algorithm declares that our portfolio be empty. If the day consists of N ticks, then the idle time for the day is defined as

idle time:={nε(1,2, . . . ,N):Δₙ=0}

The percent idle time in a day is simply

$$\frac{\vert idle time \vert}{N} .$$

If there are R subperiods in a day, this is

$$\vert idle time \vert = {\sum }_{l = 0}^{R - 1} ( {T}_{α ( l ) + 1} - {T}_{α ( l )} ) + ( N - {T}_{α ( R )} )$$

where T_{α(R)}=N if the final subperiod's end is induced by the end-of-day settling the algorithm requires. The average number of subperiods per day can be estimated by

$$\frac{N}{E ( T ) [ E ( Y ) + 1 ]} ,$$

and so, since there is the length of one signal between each subperiod, the average amount of idle time in a day can be estimated as the average number of subperiods per day multiplied by the average time to a signal, i.e.

$$\frac{N}{E ( T ) [ E ( Y ) + 1 ]} \cdot E ( {T}_{1} ) = \frac{N}{E ( Y ) + 1} .$$

Then, the percent idle time in a day is estimated by this value divided by the number of ticks per day, or simply

$$\frac{1}{E ( Y ) + 1} .$$

Table 9 to Table 14 (see U.S. provisional patent application 62/043,886, the content of which is hereby incorporated by reference) contain the results of simulations. Table 9 contains experimental averages of the following values for the lazy symmetric random walks: (1) average gain per subperiod, which can be seen to be close to E(G₁)=0 in all cases due to symmetry; (2) average subperiod length, which approximates the expected value E(T₁)E(Y₁): for example, p₀=0.1 has

$$7.670 \approx ( \frac{2 - 0.1}{1 - 2 {( 0.45 )}^{2} - 0.1} ) ( 2 ) = 3. \overline{83} ( 2 ) = 7. \overline{67} ;$$

(3) average number of signals per subperiod, which approximates E(Y₁)+1: for example, p₀=0.1 has 2.998≈2+1=3; (4) average number of subperiods per day, which approximates R above (which is itself, approximated above by

$$\frac{N}{E ( T ) [ E ( Y ) + 1 ]} ) ;$$

for p₀=0.1, this is

$$435.185 \approx \frac{5000}{3. \overline{83} ( 3 )} \approx 434.21 ;$$

and (5) the average percent idle time; for p₀=0.1, this is

$$33.2 \% \approx \frac{1}{E ( Y ) + 1} \approx \frac{1}{3} .$$

The remaining tables contain similar experimental data for various lazy simple random walks. Results of simulations using frequencies derived from the real data from the 5-year and 30-year bonds are shown in Table 6 Table 7 and Table 8 of U.S. provisional patent application 62/043,886, the content of which is hereby incorporated by reference.

U.S. provisional patent application 62/043,886 also illustrates Table 9, Table 10, Table 11 and Table 12. Table 10 contains detail on the subperiods of these walks: (1) the average number of subperiods with a specific number of signals; for example, p₀=0.1, subperiod length n=4 has 27.31, which, when divided by the average total number of subperiods 435.185 from Table 9, gives

$$\frac{27.31}{435.185} \approx 0.06275 \approx P ( {T}_{1} = 4 ) = 0.625 ;$$

and (2) the average gain on such a subperiod of length n−4, which is 3.64 E(G₁|Y₁=4)=3.478. Table 11 and Table 12 contain the same experimental values as Table 9 and Table 10, this time from the simple random walk discussed elsewhere in this specification. For example, in Table 11, examining p₁=0.65, we have (1) average gain per subperiod 16.378≈E(G₁)=16.481; (2) average subperiod length 13.749≈E(Y₁)·E (T₁)≈3.7389·3.6697=13.7208; (3) average number of signals per subperiod 4.746≈E(Y₁)+1=4.7389; (4) average number of signals per subperiod

$$288.120 \approx \frac{N}{E ( T ) [ E ( Y ) + 1 ]} = \frac{5000}{3.6697 ( 4.7389 )} = 287.516 ;$$

and (5) average percent idle time

$$20.8 \% \approx \frac{1}{E ( Y ) + 1} = \frac{1}{4.7389} = 21.10 \% .$$

The Effect of the Threshold Parameter

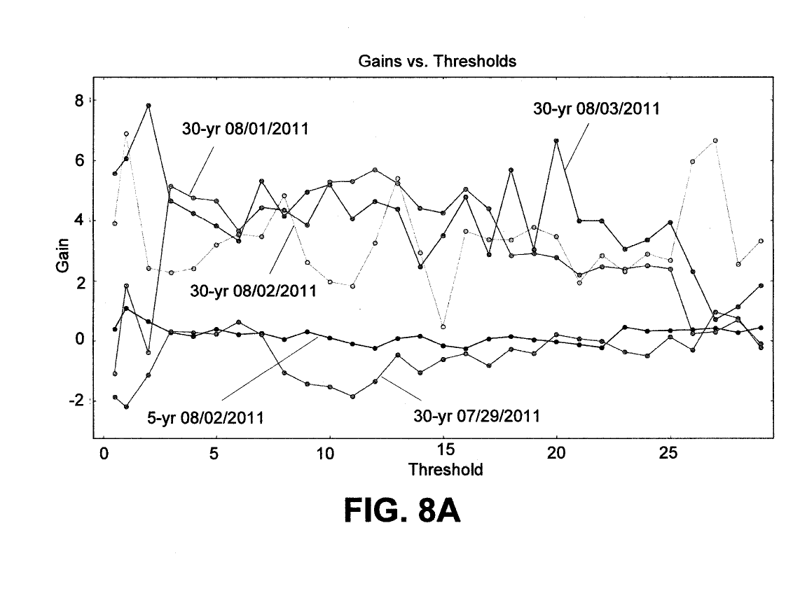

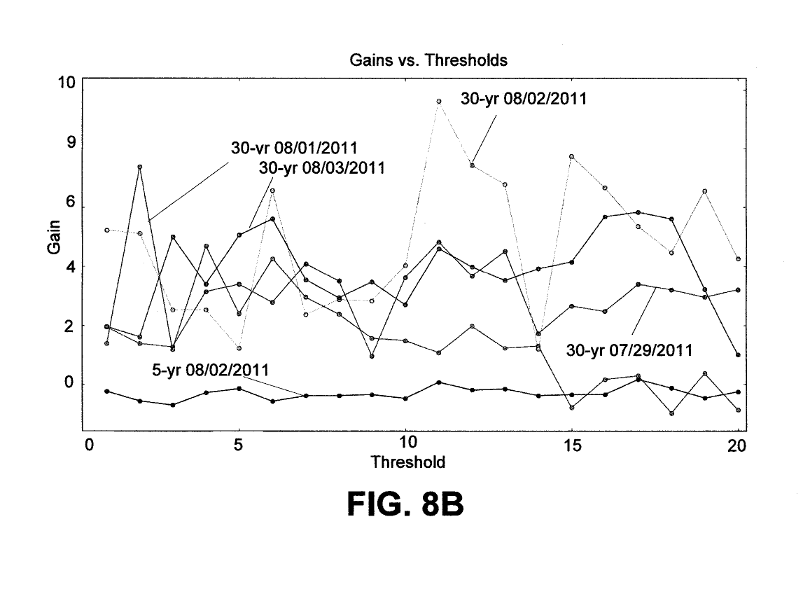

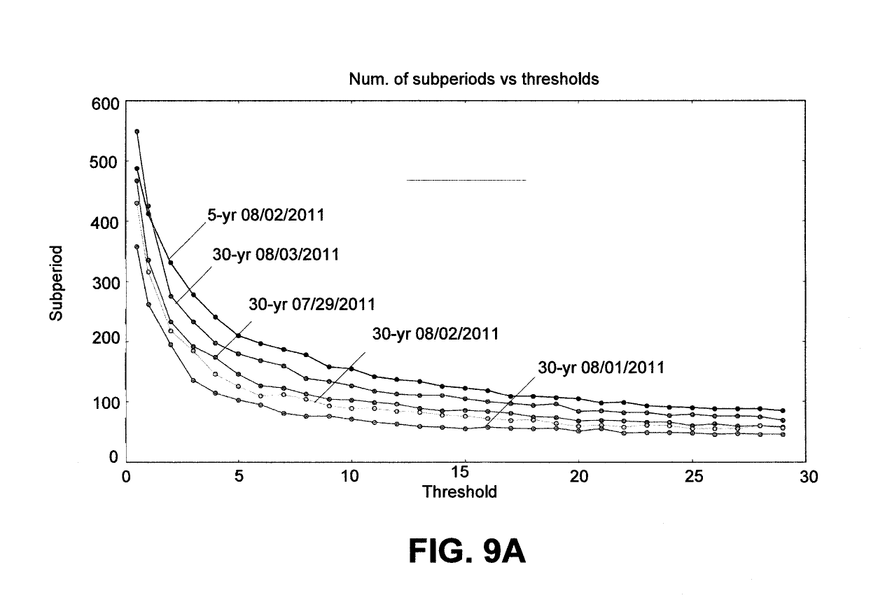

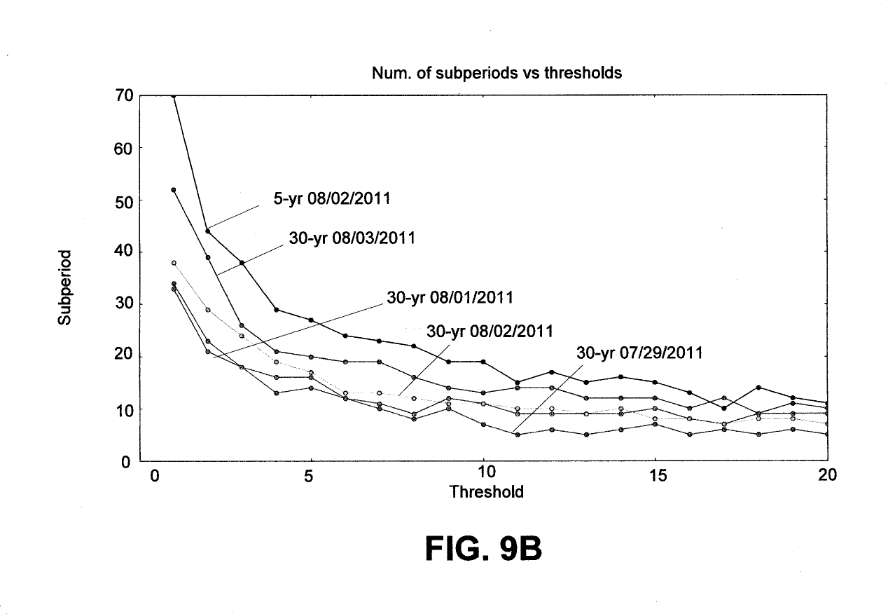

FIG. 8A and FIG. 8B depict the effect of varying the threshold parameter h on the disclosed method. Specifically, FIG. 8A and FIG. 8B show that varying the threshold does not change the sign of the gain. In fact, varying the threshold in the 5-year note leaves the daily gain almost unchanged, while in the 30-year bonds, although a more random variation is observed, no apparent pattern of an increasing or decreasing effect on the gain is observed. This demonstrates a level of robustness of the proposed strategy's gain as a function of the threshold. A closer examination shows that the number of signals per subperiod is almost constant regardless of the threshold size, as seen in the column “average # of signals per subperiod” in Table 1, Table 2, Table 3, Table 4 and Table 5 of U.S. provisional patent application 62/043,886, the content of which is hereby incorporated by reference. Yet, the number of subperiods per trading day decreases as the threshold increases. FIG. 8A vary small thresholds as follows: 0.5*tick, tick, 2*tick, 3*tick, etc. (up to 29*tick). FIG. 8B vary large thresholds as follows: 50*tick, 2*50*tick, 3*50*tick, etc. (up to 20*50*tick). This is seen in FIG. 9A and FIG. 9B, where the number of signals per trading day decreases at the rate of the square root of the threshold. FIG. 9A vary small thresholds as follows: 0.5*tick, tick, 2*tick, 3*tick, etc. (up to 29*tick). FIG. 9B vary large thresholds as follows: 50*tick, 2*50*tick, 3*50*tick, etc. (up to 20*50*tick).

Finally, in some embodiments, the multiple ticks are used with the mₖ^{u} and

$${m}_{k}^{d} to ( e . g . {m}_{k}^{u} = {S}_{{T}_{k}} + \frac{bM}{2} for some b > 1 ) .$$

In view of the foregoing, embodiments of the invention limit the risk associated with large positions in asset trading. A technical effect is to increase the profitability of such trading.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “service,” “circuit,” “circuitry,” “module,” and/or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a non-transient computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code and/or executable instructions embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

A processor can be or include one or more device(s) for automatically operating on data, e.g., a central processing unit (CPU), microcontroller unit (MCU), desktop computer, laptop computer, mainframe computer, personal digital assistant, digital camera, cellular phone, smartphone, or any other device for processing data, managing data, or handling data, whether implemented with electrical, magnetic, optical, biological components, or otherwise.

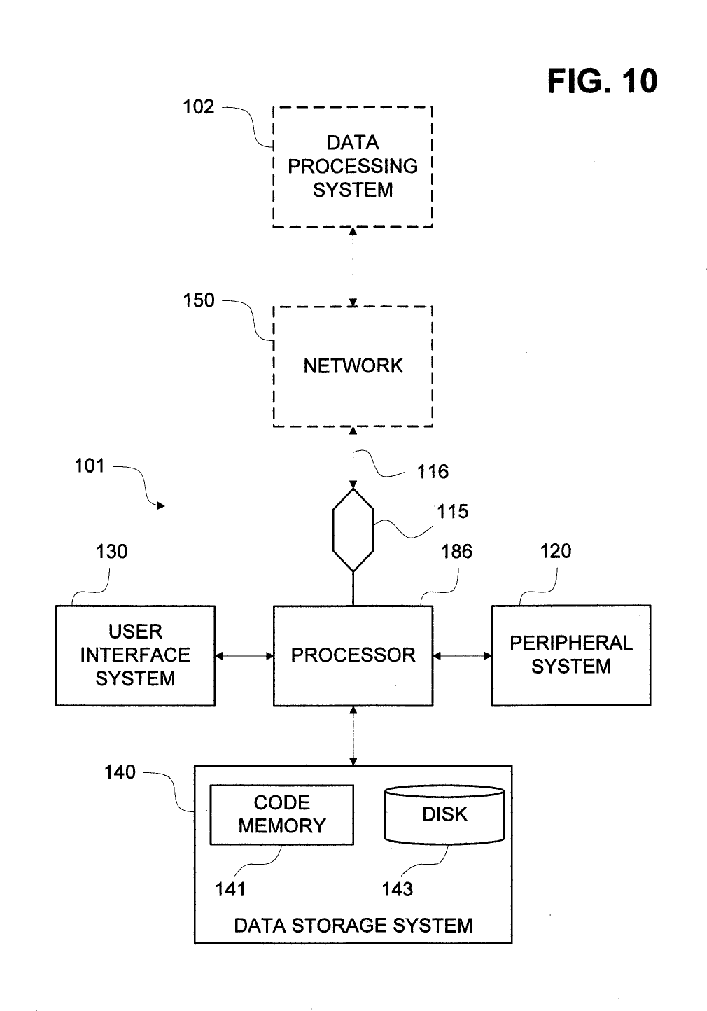

The phrase “communicatively connected” includes any type of connection, wired or wireless, for communicating data between processors. Referring to FIG. 10, these processors 186 can be located in physical proximity or located in remote locations. For example, subsystems 101 such as a peripheral system 120, a user interface system 130, and a data storage system 140 (which may include a code memory 141 and/or a disk 143) may be separate from a data processing system 102 by a network 150. Alternatively, these subsystems 101 may be stored completely or partially within the data processing system 102.

The peripheral system 120 can include one or more devices configured to provide digital content records to the processor 186. For example, the peripheral system 120 can include digital still cameras, digital video cameras, cellular phones, or other data processors. The processor 186, upon receipt of digital content records from a device in the peripheral system 120, can store such digital content records in the data storage system 140.

The user interface system 130 can include a mouse, a keyboard, another computer (connected, e.g., via a network or a null-modem cable), or any device or combination of devices from which data is input to the processor 186. The user interface system 130 also can include a display device, a processor-accessible memory, or any device or combination of devices to which data is output by the processor 186. The user interface system 130 and the data storage system 140 can share a processor-accessible memory.

In other embodiments, the processor 186 includes or is connected to communication interface 115 that is coupled via network link 116 (shown in phantom) to the network 150. For example, communication interface 115 can include an integrated services digital network (ISDN) terminal adapter or a modem to communicate data via a telephone line; a network interface to communicate data via a local-area network (LAN), e.g., an Ethernet LAN, or wide-area network (WAN); or a radio to communicate data via a wireless link, e.g., WiFi or GSM. Communication interface 115 sends and receives electrical, electromagnetic or optical signals that carry digital or analog data streams representing various types of information across network link 116 to network 150. Network link 116 can be connected to network 150 via a switch, gateway, hub, router, or other networking device.

Processor 186 can send messages and receive data, including program code, through network 150, network link 116 and communication interface 115. For example, a server can store requested code for an application program (e.g., a JAVA applet) on a tangible non-volatile computer-readable storage medium to which it is connected. The server can retrieve the code from the medium and transmit it through network 150 to communication interface 115. The received code can be executed by processor 186 as it is received, or stored in data storage system 140 for later execution.

Data storage system 140 can include or be communicatively connected with one or more processor-accessible memories configured to store information. The memories can be, e.g., within a chassis or as parts of a distributed system. The phrase “processor-accessible memory” is intended to include any data storage device to or from which processor 186 can transfer data (using appropriate components of peripheral system 120), whether volatile or nonvolatile; removable or fixed; electronic, magnetic, optical, chemical, mechanical, or otherwise. Exemplary processor-accessible memories include but are not limited to: registers, floppy disks, hard disks, tapes, bar codes, Compact Discs, DVDs, read-only memories (ROM), erasable programmable read-only memories (EPROM, EEPROM, or Flash), and random-access memories (RAMs). One of the processor-accessible memories in the data storage system 140 can be a tangible non-transitory computer-readable storage medium, i.e., a non-transitory device or article of manufacture that participates in storing instructions that can be provided to processor 186 for execution.

In an example, data storage system 140 includes code memory 141, e.g., a RAM, and disk 143, e.g., a tangible computer-readable rotational storage device such as a hard drive. Computer program instructions are read into code memory 141 from disk 143. Processor 186 then executes one or more sequences of the computer program instructions loaded into code memory 141, as a result performing process steps described herein. In this way, processor 186 carries out a computer implemented process. For example, steps of methods described herein, blocks of the flowchart illustrations or block diagrams herein, and combinations of those, can be implemented by computer program instructions. Code memory 141 can also store data, or can store only code.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of establishing a cumulative sum (CUSUM) tracking strategy that limits large positions and identifies real trading trends, the method comprising steps of:
a) monitoring a sequence (Yₙ) of data points over time, the sequence of data points corresponding to a price of an asset;
b) classifying a change in price at time (n) relative to time (n−1) by a sequence trend, the sequence trend selected from an upward trend (u) in the price or a downward trend (d) in the price;
c) calculating an upward cumulative sum (uₙ) of a possible upward trend (u) and a downward cumulative sum (dₙ) of a possible downward trend (d);
d) comparing the upward cumulative sum (uₙ) to an upward threshold (h⁺) and the downward cumulative sum (dₙ) to a downward threshold (h⁻) to determine deviation from a mean by an amount greater than the respective threshold, wherein an alarm is fired when the respective threshold is exceeded, the alarm having an alarm type selected from an upward alarm type and a downward alarm type corresponding to the upward trend (u) and the downward trend (d), respectively, wherein only one alarm may fire at a time;
e) performing a buy action that buys at least one share of the asset during the upward trend or performing a sell action that sells at least one share of the asset during the downward trend;
f) repeating steps a) to e) for successive changes in price until the alarm is fired denoting an end of the sequence trend and thereafter:
initiating a sell action at an end of the upward trend or initiating a buy action at an end of the downward trend;
restarting the method with newly-initialized upward cumulative sum (uₙ) and downward cumulative sum (dₙ).

2. The method as recited in claim 1, wherein the upward cumulative sum (uₙ) and the downward cumulative sum (dₙ) are given by:
$${u}_{n} := max \{ 0 , {u}_{n - 1} + ( {Y}_{n} - \frac{{μ}_{1} + {μ}_{0}}{2} ) \}$$
$${d}_{n} := max \{ 0 , {d}_{n - 1} + ( {Y}_{n} - \frac{{μ}_{1} + {μ}_{0}}{2} ) \} .$$

3. The method as recited in claim 1, wherein the upward threshold and the downward threshold are the same.

4. The method as recited in claim 1, wherein the step of comparing utilizes a two-sided CUSUM (2-CUSUM).

5. The method as recited in claim 1, wherein the method leads to profit during both the upward trend and during the downward trend.

6. A program storage device readable by machine, tangibly embodying a program of instructions executable by machine to perform the method steps for establishing a cumulative sum (CUSUM) tracking strategy that limits large positions and identifies real trading trends comprising steps of:
a) monitoring a sequence (Yₙ) of data points over time, the sequence of data points corresponding to a price of an asset;
b) classifying a change in price at time (n) relative to time (n−1) by a sequence trend, the sequence trend selected from an upward trend (u) in the price or a downward trend (d) in the price;
c) calculating an upward cumulative sum (uₙ) of a possible upward trend (u) and a downward cumulative sum (dₙ) of a possible downward trend (d) wherein the upward cumulative sum (uₙ) and the downward cumulative sum (dₙ) are given by:
$${u}_{n} := max \{ 0 , {u}_{n - 1} + ( {Y}_{n} - \frac{{μ}_{1} + {μ}_{0}}{2} ) \}$$
$${d}_{n} := max \{ 0 , {d}_{n - 1} + ( {Y}_{n} - \frac{{μ}_{1} + {μ}_{0}}{2} ) \} .$$
d) comparing the upward cumulative sum (uₙ) to an upward threshold (h⁺) and the downward cumulative sum (dₙ) to a downward threshold (h⁻) to determine deviation from a mean by an amount greater than the respective threshold, wherein an alarm is fired when the respective threshold is exceeded, the alarm having an alarm type selected from an upward alarm type and a downward alarm type corresponding to the upward trend (u) and the downward trend (d), respectively, wherein only one alarm may fire at a time;
e) performing a buy action that buys at least one share of the asset during the upward trend or performing a sell action that sells at least one share of the asset during the downward trend;
f) repeating steps a) to e) for successive changes in price until the alarm is fired denoting an end of the sequence trend and thereafter:
initiating a sell action at an end of an upward trend or initiating a buy action at an end of a downward trend;
restarting the method with newly-initialized upward cumulative sum (uₙ) and downward cumulative sum (dₙ).

7. The program storage device as recited in claim 6, wherein the upward threshold and the downward threshold are the same.

8. The program storage device as recited in claim 6, wherein the step of comparing utilizes a two-sided CUSUM (2-CUSUM).

9. The program storage device as recited in claim 6, wherein the step of repeating steps a) to e) is repeated at least once per day.

10. The program storage device as recited in claim 6, wherein the step of repeating steps a) to e) is repeated at least three times per day.

11. The program storage device as recited in claim 6, wherein the step of repeating steps a) to e) is repeated at least one hundred times per day.
